(19) United States
(12) Patent Application Publication
(10) Pub. No.: US 2017/0134467 A1
(43) Pub. Date: May 11, 2017

(54) DATA STREAM MONITORING

(71) Applicant: Been, Inc., New York, NY (US)

(72) Inventors: David H. Yoon, New York, NY (US); Sang Y. Shin, San Jose, CA (US)

(21) Appl. No.: 15/381,836

(22) Filed: Dec. 16, 2016

Related U.S. Application Data
(63) Continuation of application No. 14/611,019, filed on Jan. 30, 2015, now abandoned.
Application No. 14/611,019 is a continuation-in-part of application No. 14/449,073, filed on Jul. 31, 2014, now abandoned.
(60) Provisional application No. 61/860,453, filed on Jul. 31, 2013.
(60) Provisional application No. 61/860,465, filed on Jul. 31, 2013.

(51) Int. Cl. H04L 29/06; G06Q 30/02

(52) U.S. Cl. CPC H04L 65/602; G06Q 30/0277; G06Q 30/0201; H04L 67/02

(57) ABSTRACT

A computer platform and network for sharing of data streams and demographic information of users browsing the Internet with content providers and advertisers. The technology further relates to a graphical user interface for representing data streams and selectively recorded data elements for individuals and groups of individuals in both linear and popular (most visited) views. The technology still further includes permitting an intentional delay in recording data elements via the graphical interface, with controls for the user to control or override the delay.

### CLAIM OF PRIORITY

This application is a continuation of U.S. application Ser. No. 14/611,019, filed Jan. 30, 2015, which is a continuation-in-part of U.S. application Ser. No. 14/449,073, filed Jul. 31, 2014, which application claims the benefit of priority under 35 U.S.C. §119(e) to U.S. provisional application Ser. No. 61/860,391, filed Jul. 31, 2013, 61/860,453, filed Jul. 31, 2013, and 61/860,465, filed Jul. 31, 2013, all of which are incorporated herein by reference in their entirety.

### RELATED APPLICATIONS

The instant application is also related to the following U.S. patent applications, all of which are incorporated herein by reference in their entireties:
Yoon, D., et al., utility application Ser. No. 14/449,111, filed Jul. 31, 2014, entitled “SYNCHRONIZED WEB BROWSING”, attorney docket no. 1757-00-003U01;
Yoon, D., et al., provisional application Ser. No. 61/860,408, filed Jul. 31, 2013, entitled “GRAPHICAL INTERFACE AND DATABASE FOR CLICKSTREAM MONITORING AMONGST GROUPS OF USERS”, attorney docket no. 1757-00-003P01;
Yoon, D., et al., provisional application Ser. No. 61/860,417, filed Jul. 31, 2013, entitled “SYNCHRONIZED WEB BROWSING IN REAL TIME”, attorney docket no. 1757-00-004P01; and
Yoon, D., et al., provisional application Ser. No. 61/860,431, filed Jul. 31, 2013, entitled “CONTENT TAGGED TO WEB-PAGES”, attorney docket no. 1757-00-005P01.

### TECHNICAL FIELD

The technology described herein generally relates to a platform and network for sharing data streams and demographic information of users browsing the Internet with content providers and advertisers. The technology described herein further relates to a graphical user interface for representing data streams and data elements graphically in both linear and popular (most visited) views. The technology described herein further includes permitting an intentional delay in recording data streams via the graphical user interface.

### BACKGROUND

The data streams of Internet users arguably rank as some of the most valuable information available for understanding users' needs and preferences, both online and offline. Analyzing the data streams would help identify and estimate the impact of the information the users receive and create, as well as how their opinions, tastes, and preferences form and change over time. Nevertheless, due to the ease and speed with which users of the Internet can generate data that is communicated to and from servers and network devices over various networks, particularly cellular WANs or wired or WiFi LANs, in any given amount of time, it has become more and more difficult for anyone to assess and take stock of the information transmitted.

Today, organizations (both commercial and otherwise) seek information about users' data streams so that they can then identify and target users with content and advertisements. The dominant paradigm for doing this is to track users' data in the “background,” avoiding as much as possible an explicit dialog with, and assent of, the users whose data is being captured, thereby avoiding disclosing the extent of the tracking and the value of the tracked information to the organization. However, this paradigm has come under some scrutiny. One way for this dominant paradigm to shift is to have the users collect their own data streams. In many ways, voluntary, but explicitly authorized, recordings of users' data streams by the users themselves would be superior to “background” recordings by third parties.

Even so, the possibility of an unwanted recording is one of the most significant impediments to effecting change in the way that data streams are accessed. Users also need to feel absolutely certain that the data streams that they want recorded, and not others, are recorded. This is true even when a user has the ability to erase recordings after the fact.

Accordingly, there is a need for a platform that allows for both more useful data for the creation of personalized and targeted content and advertisements, as well as greater control of the sharing of user data streams by the users themselves.

Such a platform should have a capability for users to control what data is being recorded, while in a recording session, through an application that records their data elements and data streams, as well as to prevent certain data from that data stream from being recorded at any time.

Furthermore, given the value of the information present in data streams, other tools to facilitate their analysis would be beneficial. Though there exist applications to show visual representations of a series of data elements from a data stream, or text lists, and text lists of most often accessed content or activities, much additional information could be provided if ways could be found to quickly and efficiently display a user's data stream in a manner that highlighted content or actions that the user found popular as well as those performed or considered popular within the user's community.

The ability to block third parties from collecting users' data streams and serving them advertisements without consent exists today in various implementations. While this capability is not new, it has not previously been combined with a data exchange.

The discussion of the background herein is included to explain the context of the technology. This is not to be taken as an admission that any of the material referred to was published, known, or part of the common general knowledge as at the priority date of any of the claims found appended hereto.

Throughout the description and claims of the specification the word “comprise” and variations thereof, such as “comprising” and “comprises”, is not intended to exclude other additives, components, integers or steps.

### SUMMARY

The instant disclosure addresses methods and apparatus for recording and sharing a user's data streams, in conjunction with a server or network device. In particular, the disclosure comprises a computer program configured to permit one or more users to record and share their data streams, the computer program being executable as a browser extension or an application on a desktop or laptop computer, or as an app on a mobile device such as a smartphone or tablet computer, wherein the computer or mobile device is in communication via a network connection with a server or network device.

The present disclosure provides for a computing apparatus for managing a user's data streams, the apparatus comprising: a network connection; a computer-readable memory, encoded with instructions; a processor configured to execute the instructions; wherein the instructions provide for: recording a user's data stream, wherein the data stream comprises two or more data elements, which include but are not limited to URL's from the user's network device; associating one or more pieces of user-specific information with each of the data elements; and sharing the data elements from the data stream with one or more third parties. The same computing apparatus may be configured to perform the foregoing operations on two or more of the user's data streams.

The present disclosure further provides for a method for managing a user's data stream, the method comprising: recording a user's data stream, wherein the data stream comprises two or more data elements which include but are not limited to URL's from the user's network device; associating one or more pieces of user-specific information with each of the two or more data elements; and sharing the data stream with one or more third parties, wherein the method is performed on a computing apparatus. The disclosure further includes a computer-readable medium encoded with instructions for implementing the foregoing method for managing a user's data streams.

The present disclosure still further provides for a computing apparatus for displaying a user's data stream, the apparatus comprising: a network connection; a computer-readable memory encoded with instructions; a processor configured to execute the instructions; wherein the instructions provide for: recording the data stream of a user, wherein the data stream comprises one or more data elements; storing the data stream in a database; generating an icon for each of the one or more data elements; and displaying, on a computer display, the icon for each of the one or more data elements.

The present disclosure additionally provides for a method for displaying a user's data stream, the method comprising: recording the data stream of a user, wherein the data stream comprises one or more data elements; storing the data stream in a database; generating an icon for each of the one or more data elements; and displaying, on a computer display, the icon for each of the one or more data elements; wherein the method is performed on a computing apparatus. The present disclosure further provides for a computer-readable medium encoded with instructions for implementing the foregoing method for displaying a user's data stream.

The present disclosure additionally includes a computing apparatus for, while recording a user's data stream, introducing a delay in recording data elements which are part of the use's data stream, and an ability to override that delay by the user, the apparatus comprising: a network connection; a computer-readable memory encoded with instructions; a processor executing the instructions; wherein the instructions provide for: recording a user's data stream; producing a delay in the recording of a data element, wherein the delay can be overridden by performing an action that generates another data element such as navigating to another URL, or by instructing the web browser extension or app; and visually informing the user of both the delay and, after the delay period has passed, the fact of recording the data element to a database of the user's data streams.

The disclosure further provides a method of, while recording a user's data stream, introducing a delay in recording of data elements from the data stream, the method comprising: recording a user's data stream; setting a delay in the recording of a data element to be a certain amount of time after the requesting of that data element; recording the data element after the delay period has passed, or if the user by some action generates another data element within the period of the delay, or if the user instructs the web browser extension or app to override the delay; visually indicating one or more of: when the delay is in place or active, when the delay is completed, and the recording of the data element; and storing the user's data element into a database of the user's data streams; wherein the method is performed on a computing apparatus. The disclosure also comprises a computer-readable medium encoded with instructions for implementing the foregoing method of, while recording a user's data stream, introducing a delay in recording of data elements.

### BRIEF DESCRIPTION OF THE DRAWINGS

FIG. 1 shows a selection of exemplary icons that can be associated with data streams such as URL's.

FIG. 2 shows an exemplary browser-based recording interface, with an exemplary notification of a delay in recording when a user navigates to a new page (the color of button 203, denoted as—say—yellow, indicates that a delay is in effect.

FIG. 3 shows an exemplary data structure for storing group properties with recorded data stream data such as URL/URI data.

FIG. 4 shows an exemplary graphical view of selectively recorded data elements (URL's/URI's in this example) or chronological data streams (web-pages depicted by thumbnails in this example). Each data element is represented by an icon that resembles a leaf.

FIG. 5 shows an exemplary graphical view of selectively recorded data elements (URL's/URI's in this example) or chronological data streams sorted by popularity over different time periods (web-pages depicted by thumbnails based on popularity in this example).

FIG. 6 shows a tabular view of textual descriptions of combined data streams of one or more users. (The view can show the data streams of a single user, or an aggregate of data streams from multiple users.)

FIG. 7 shows a schematic implementation of the technology of the present invention on a client device.

FIG. 8 shows a schematic diagram of a computer configured to run the data stream monitoring programs described herein.

FIGS. 9A and 9B show an exemplary end to end system diagram for a system configured to run the data stream monitoring programs described herein.

Like reference symbols in the various drawings indicate like elements.

### DETAILED DESCRIPTION

The technology described herein comprises a platform that allows for both the creation of personalized and targeted content and advertisements, and control of the recording and sharing of users' data streams by the users themselves.

In particular, the instant technology includes a method for acquiring, storing, calculating, and displaying data stream histories of individual users as well as groups of users, either selectively or comprehensively. Calculations can be carried out by, for example, grouping data and ranking them according to factors including but not limited to the number of individual views, the average duration of time spent on a data element, and the number of referrers. Groups of users can be both voluntarily formed (e.g., by the users themselves), or formed for analytical purposes (such as by a third party) to identify and understand distinct behavioral segments in populations.

It is to be understood that the technology, for example the server, is compatible with any client-side device, such as a personal computer or a mobile device.

Accordingly, the technology herein is compatible with any web-browser software, including but not limited to: Internet Explorer, Safari, Chrome, FireFox, and Opera, and any version thereof.

On mobile devices, the technology is compatible with application software, such as iOS (for example, iO54, iO55, iO56, iO57, and iO58 and intermediate versions and updates thereof), Android, Windows operating systems (such as Windows Phone7.5, Windows8, Windows9, and Windows10), and any versions thereof.

### DEFINITIONS

URL and URI—uniform resource locator and uniform resource identifier, respectively. It is assumed herein that a reference to any one of: URL/URI, URI, or a URL, means either a URL or a URI or both.

Data stream—an individual's stream of data generated by a user's network device communicating with servers or other network devices over networks including but not limited to: cellular WANs, wired or WiFi LANs, Bluetooth, and NFC data connections. A data stream encompasses all data communication between the network device and servers or other network devices they connect to using any one or more of the following protocols:
Internet Protocol TCP/IP (for example, HTTP, SMTP, VoIP)
Audio/Video (for example, RTSP, RTMP)
Messaging (for example, SMS, MMS)
Gelocation (for example, GPS, Cell-ID)
Near Field Communication (for example, SNEP, LLCP)
Bluetooth (for example, BLE)
Infrared Emitter (for example, Anymote)

The term “data stream” may also be written as “click-stream” or “click stream” herein, without changing or limiting its meaning.

Data element—a specific component or “element” within a data stream. While data elements differ across data communication protocols, they are all individually identifiable data markers that the communication protocols use to service applications. Examples of data elements include: data elements for the HTTP(S) data communication protocol, where the data elements in sum or individually may represent app screens or web pages. Another example of a data element is the MAIL command for the SMTP data communication protocol. Further examples of data elements are provided elsewhere herein.

Network device—a combination of hardware and software components that enables a user to view and update content on a server or another network device on a network. The term network device includes, but is not limited to, suitably programmed desktop computers, and mobile devices such as laptops, notebooks, smart phones, tablets, wearable devices or gear, and audio, Bluetooth or wireless listening beacons.

Internet Browsing Device—a combination of hardware and software components that enables a user to view and update content on the Internet. The term network browsing device includes, but is not limited to desktop computers, and mobile devices such as laptops, notebooks, smart phones, and tablets.

Browser extension—a computer program that extends the functionality of a web browser.

API (application programming interface)—a program that functions over the standard Internet and intranet communication protocols, and which enables disparate web sites and web applications implemented in different technology stacks to exchange and process data securely with each other.

Referrer—the preceding app or content that initiated the loading of a new data element. There are many use cases that fall under this definition. For example, the preceding app could be a URL/URI of a web page from which the user clicked a link to navigate to another page. It can also be the prior tab or window the user was viewing before switching to another tab or window. It can also be the currently-loaded web page before a user types a new URL/URI in a browser's address bar and hits “enter” or “return”. It can also be an app request or update that was issued before a URL/URI was loaded in a web browser. Such a process can be referred to as an “app event”. As an example, an app event could comprise a tap of the screen within the running app that causes the app to execute some instructions in the background. Thus the referrer can even be an app event that was issued before another app event within the same app or through another app.

Advertising and Auction Exchange—a marketplace where user data can be put up for sale and offered to commercial or noncommercial organizations or individuals for purchase, or put up for auction to be bid by commercial or noncommercial organizations or individuals.

Browser extension—a computer program that extends the functionality of a web browser.

### Overview

The instant technology is directed to systems and methods for recording and organizing users' data streams, including permitting a user to delay such a recording, and to providing methods of sharing the particular data elements of a data stream.

The instant technology further includes a graphical user interface for representing data streams for individuals and groups of individuals. An efficient visual representation of these ordered data stream histories constitutes a tool for both archival and discovery.

A preferred implementation of the technology is a client such as an Internet browser extension (or “add on”) used in conjunction with an Internet browser, such as Internet Explorer, Safari, FireFox, Chrome, or Opera, or a mobile device running an app that connects to the server.

### Display

The methods described herein allow for the display of a series of data elements in a data stream, for example URLs/URIs representing web pages as thumbnails that can be customized by any or all of the following parameters: number of views or aggregate time period viewed by the user and/or voluntary or otherwise comprised groups of individuals, and subject matter. The display can be in either time series format, or an order ranked by the number of visits or duration of views. It is to be understood that the foregoing list of parameters is neither exclusive nor exhaustive.

The ability to show a time series of data elements as well as a ranked order for a group of users can become useful where, for example, the data elements are URLs/URIs representing web pages, and the users in the group have similar interests, the group is researching the same subject matter, the group is comprised of members from the same family, friendship group, commercial or fraternal organization, as well as other possible categorizations. An ordered representation of the web browsing history provides the group members with the ability to narrow their browsing in search of relevant information as well as share their own histories passively. It becomes a tool by which material may be discovered that may be only tangential to a particular topic of interest but is in fact potentially relevant to it.

### Recording

A collection of data elements for an individual or a group of individuals can be collected, and can have a number of associated characteristics, any of which can be recorded to a database. Creating a database of such characteristics provides a convenient mechanism for managing and manipulating the data elements that underlie a data stream. This is useful for a user who wishes to record their data streams for their own use, or to share with others, including companies and other third party providers who could use the data to provide a better web experience to the user.

Users can record groups of data streams, created for example in the context of a targeted search or a multi-user app session, in order to share with third parties that can provide services in return, thereby making the users' data streams topic-specific and more likely to be relevant to a potential transaction with the third party. For example, if the data elements of a data stream are URL's/URI's representing web pages and a user carries out a sequence of searches in connection with a vacation plan, and browses web-sites associated with flight and hotel booking, rental car reservation, and admission tickets for attractions at the vacation location, then third parties at the location may provide further suggestions to the user. Users can also record the data stream to a single place, across multiple devices, and multiple browsing applications, because the data stream data is stored on a server in an account associated with the user.

Recording, editing, and viewing of data streams, and creating chronological or historical lists of behavior on the Internet, can be accomplished by the following functions:
a. Data elements from a data stream are recorded to a database whenever there are data communication exchanges between the user's network device and the server or other network devices it connects to, across multiple devices, operating systems, and applications, wherever and whenever the user has switched the recording function to record.
b. Data elements from a data stream can be recorded into user-created files (for example, denoted by a distinctive graphical icon (such as a leaf) and user-determined name for that file), and there can be multiple files for each user.
c. Each data element can be recorded to multiple files simultaneously. Users can determine whether a data element is recorded or not, and whether it is recorded to a single file or recorded to multiple files.
d. There can be a fixed time duration delay in recording a data element when a network device communicates with a server or another network device, should the user prefer not to record the new data element.
e. Users can edit the recordings after data elements have been recorded by deleting the data elements that they do not want in their recordings, using either a text-based interface or a graphical interface.
f. Users can view their recordings of data elements recorded within each file/grouping, through either a text-based interface or a graphical interface, with each page visited being represented, for example, as a separate icon. The order in which the recorded pages are displayed can be alternated by the user between chronological (such as the chronological order by which the user recorded or visited the pages) and most-visited, as well as other orderings such as by subject grouping, or by alphabetical order of page title or URL/URI.

Data elements can be potentially any type of data that can be broadcast over a computer network. The types of possible data element vary according to the data stream in question, and also vary according to particular type of data stream within a category of data streams.

Thus, data elements that are part of the Internet Protocol include, for HTTP(S): URL/URIs; User-Agents which identify the application issuing requests; and message body; for SMTP: Sender; Recipient; and Message Text; for VoIP: Call-ID; Via, which is the unique identifier of the communication session; and Contact.

Data elements for audio/video include: for RTSP: transport; session; and bandwidth; for RTMP: app; tcUrl; and playpath.

Data elements for messaging include: for SMS: SCA; UD; and DA; for MMS; from; X-Mms-Response-Status; and X-Mms-Message-Type.

Data elements for Geolocation include: for GPS: WPTNME; AAM; and GP; for Cell-ID: Data packets (raw packets).

Data elements for near field communication include: for SNEP/LLCP (interoperable): NDEF message; version; and length.

Data elements for bluetooth include: PDU; time; and access address.

Data elements for infrared emitter include: data packets (raw packets).

### Data Exchange

One valuable aspect of the technology described herein is the capability for third parties to access a user's data streams, or the data streams of groups of users, by consent from users and in a manner that users can control. Thus the third parties receive data that is of higher quality and integrity than if they were attempting to obtain equivalent information by randomly intercepting a user's online activities.

Sharing of recordings with third parties can be accomplished according to the following options and limitations.

Users are able to share their recordings of data elements with third parties, combined or not combined with their volunteered demographic, personal, and contact information.

Users may or may not receive in-kind or monetary compensation in return for sharing the data. The compensation can also be of a direct donation of a financial incentive to a non-profit or charity of the user's choice. Content providers and advertisers may tailor their content and that of advertisements (whether by themselves or by other third parties) on various media platforms accessed by the user(s), including but not limited to web pages and apps, based on the data shared by the user.

Sharing can be done on a real-time basis. For example, users can go to a web page or web site and choose to share a set of recordings of their data streams with either the content provider or the advertisers on that web page. They could also choose to share their data stream with specific apps in order to immediately unlock features within the app or obtain some other benefit.

Sharing can also be done on a continuous basis, where users agree to permit the sharing to be performed in the “background” continuously through a common information exchange and processing mechanism that web-site operators and/or providers, advertisers, merchants, advertising and auction exchanges, and other third parties implement.

The common information exchange and processing mechanism can be facilitated through an API that allows content providers, advertisers, and advertising and auction exchanges, and other third parties to accept and read the recordings and ancillary data shared by the users, and change the content and/or the advertisements on the web page based on this information.

The act of sharing the data can be executed by the user either through a graphical interface or a text-based setting. An example of a graphical interface would be the dragging and dropping of the icons representing different sets of data, including users' demographic information and data streams onto the web page that offers to accept the data.

### Ad Blocking

Providing users with the ability to block third parties from collecting their data streams and to block the third parties from serving the users advertisements gives the users control and a novel choice: the ability to either block or to share their data. Coupled with the ability to derive value by sharing their data through the data exchange, users will be empowered to exercise their choice on whether to block or share their data.

### Supporting Database Structure

The database can be SQL or NoSQL in structure, although having a NoSQL structure may be more efficient for data transport by using common Internet data objects such as JSON or JSONP. In such an implementation, a NoSQL database such as MongoDB could be exposed via an API architecture using Python such as PyMongo. The API could then be connected to web services running on web servers which would transmit JSON data with clients that have the browser extensions installed.

In a larger scale deployment (>10,000 concurrent users), socket services and servers can be used to service a large number of concurrent API requests from clients.

Chronological views with linear data sets are relatively straightforward to service via API requests into the respective databases. Whether the chronological view request is for an individual user or for a group of users, all the database has to execute is a sort of the data streams by access times, which as described elsewhere herein, are stored in UTC format.

Popular views can present a performance challenge as they are grouped in different time periods per file, with each file containing one or more users' data. Calculating popular views on-demand will not be scalable, even with large hardware deployments. As such, regardless of whether a SQL or NoSQL database structure is employed, some batch background processes are implemented to essentially pre-calculate or ‘cache’ the popular view data for the files, for different time periods.

Additionally, the ability to show the most frequent destinations navigated to from the data element represented by the current icon, of users recording to a file can be calculated using the referrer data. The data element represented by the current icon may have referrer data from the user(s) who recorded the data element into the file. The database will aggregate the referrer data from the user(s) who recorded the data element to the file and store, as part of its batch process, the top five data elements for which the current data element is the referrer for, and continue this process for as many levels as configured.

By implementing the above background batch processes, one skilled in the field of database architecture and development can construct a supporting infrastructure that, when combined with a socket server deployment layer, scales to serve a large number of clients without degraded performance.

### Storage of URL/URI Histories

The recorded data element histories typically reside in a persistent storage medium such as a database. An important requirement when storing the data is that each data element, along with all of its recorded properties including, but not limited to, time of access, duration of access, referring data element, can be tagged as being part of one or more of the groups so that the data can be aggregated and structured for display and management in a flexible and expedient manner.

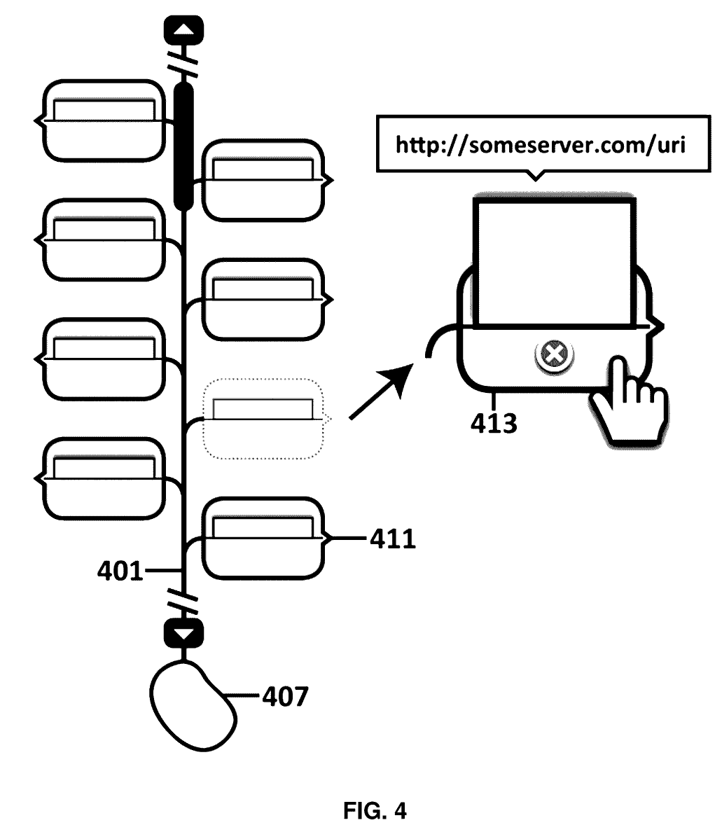

One example of how to implement such a method of storage would be to use a NoSQL database like MongoDB and python via PyMongo to create the data structure shown in FIG. 3, which can store each data element (referred to as PageView in the example of FIG. 3). Note how, in this example, BSON is used to maximize performance (BSON is a binary-encoded serialization of JSON-like documents).

### Display

The data streams and their histories can be linked to the personal and demographic information (e.g., name, age, gender, location) and contact information (e.g., e-mail address, mailing address, phone) of the user, as provided by the user to the application, or as gleaned by the system from other sources on the user's network device.

Data elements are recorded whenever an application in the user's network device communicates with a server or another network device on a network. There can be specific conditions for data elements to be recorded. For example, if the data element is a URL/URI representing a web page, it is recorded if any one of the following conditions is met:
a. The loaded URL/URI stays loaded for at least a first pre-set interval of time;
b. The user navigates away from the loaded URL/URI within a second pre-set interval of time; and
c. The network device's tab/window that displays the loaded data element is moved to the background by bringing another window/tab to the foreground within a third pre-set interval of time.

The pre-set interval of times applicable to a-c can be chosen by the user, such as selected from a list of pre-defined times (for example 0.5, 1, 2, 3, 5, 10 s), or can be set to a value chosen arbitrarily by the user. There is no requirement that all three of the pre-set intervals of time be the same as one another. The application initially assigns all of the pre-set intervals of time a default value, such as 5 s.

Time data can be recorded for each data element and can comprise the time stamp (e.g., in Coordinated Universal Time (UTC)) of when the data element is recorded, and, optionally, the length of time taken for a data element to remain the most recent before another data element is loaded.

Additional properties regarding the data element can be recorded along with the data element itself. For example, if the data element is a URL/URI representing a web page, additional web page properties that can be recorded include one or more of: web page title (e.g., from value in the <Title> HTML tag if available); referrer (e.g., the HTTP referrer as defined by the W3C (i.e., current web page accessed by clicking on a hyperlink from the previous web page); the title or address of the web page that was previously loaded before manually typing in a new web page address; the title or address of the web page of the previous tab if another tab is brought to the foreground); thumbnails of web pages, generated by a separate thumbnail server accessing saved URLs so that no personalized/private content is in the thumbnails; favicons (a set of icons associated with a particular web-site or web page) of URLs (domains) visited; viewport scrolling coordinates when “surfing together” (an activity during which members of the group access the same web-site at the same time); flag for marking a web page as a favorite; notes dropped on web pages (free form content created and saved for oneself or for others associated with a data element); browser type and version used to view the web page; and operating system type and version used to view the web page. It is to be understood that this list is not exhaustive or exclusive and that other properties of web-pages can be recorded in addition to or in place of any one of the foregoing properties. Ways to accomplish “surfing together” are described in copending application Ser. No. 14/449,111, filed Jul. 31, 2014, entitled “Synchronized Web-browsing”, having first-named inventor Yoon, David, and attorney docket no. 1757-00-003U01, incorporated herein by reference.

Preferably at least one item, e.g., the time-stamp, is recorded to a database.

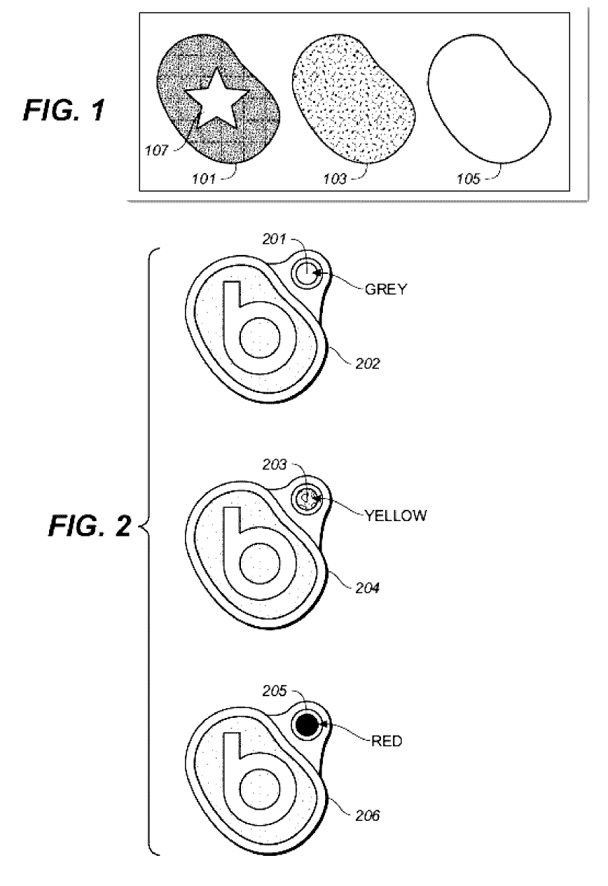

From this database, each collection of data elements can be represented as a file that includes some or all of the above data. A collection of data elements and their associated data created by the navigation behavior of a selection/subset of the population of users can be represented graphically by icons such as those shown as items 101, 103, and 105 in FIG. 1.

In the example where data elements are URLs/URIs representing web pages, each such icon 101, 103, 105 in FIG. 1 represents a file, or one or more data fields identifiable by a unique identification code in the database, which contains the Internet browsing histories of an individual or a group of individuals, bounded within certain time periods. Each individual or a group of individuals can have more than one file (and icon representing the file), with the same histories or different histories.

The icons, in the example of FIG. 1, resemble beans in shape, though other shapes such as circles, ovals, or polygons, are consistent with the operation of the technology. Each icon represents a file of the history of where an individual or a group of individuals haven been on the Internet/intranet, in a given amount of time, or in search of a topic of interest. Other commonalities of purpose may also be used to generate such an icon. For example, one bean (101 shown here with a star 107) can indicate a data element visited heavily, or which has received favorable commentaries from users. The icons can be decorated in various ways to differentiate and distinguish them one from another. For example, different color schemes, shading, borders, fill-patterns, and motifs can be used, as is indicated verbally and by shading in FIG. 1.

In a computer display, the icons are typically displayed overlaying a browser window in an unobtrusive manner. On a mobile device, the icons are typically displayed within the application, for example in a list or tabular format. The mobile device application then runs a browser from within it. That browser can be the phone's native browser (e.g., Safari on iOS) or can be a custom browser built for the app from native browser code.

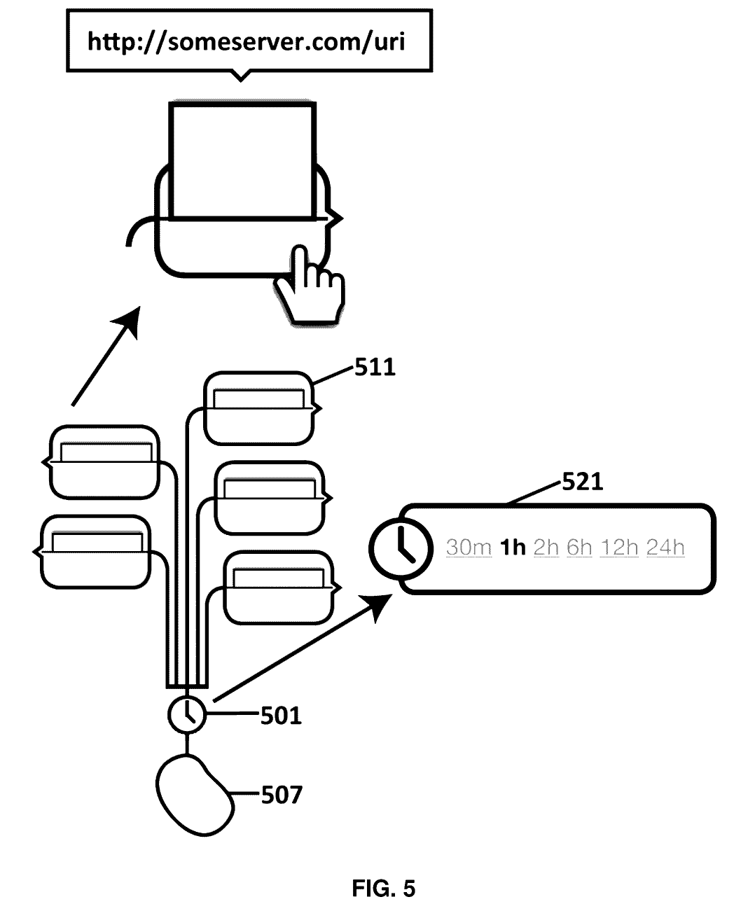

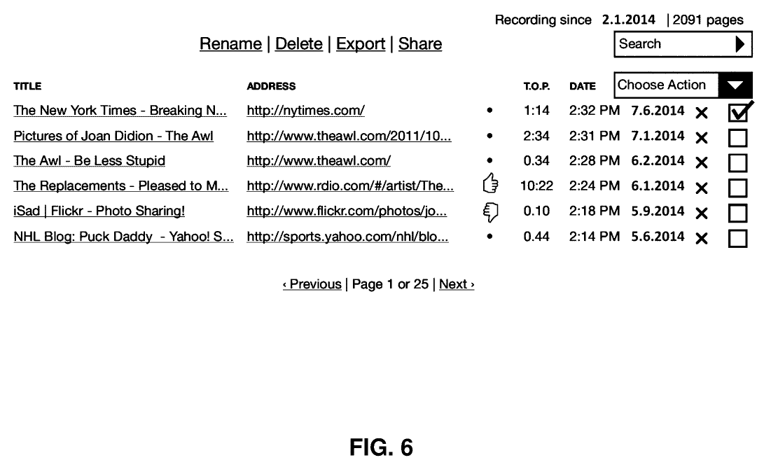

The icons are selectable in the sense that clicking on one (for example with a mouse-controlled cursor on a desktop computer, or with a finger-tap or tap of a stylus on a mobile device) will reveal the underlying data stream information associated with the icon. Two possible graphical representations to help viewers visualize the recorded data streams are: (1) chronological (FIG. 4), and (2) popularity-based (FIG. 5, e.g., based on frequency of visits within a specified time period, or aggregate duration of visits to the site).

The chronological view is a linear set of pages represented by thumbnails of the contents linked to a data element. An example is shown in FIG. 4. The pages, such as 411, are displayed as an icon that (in the example) broadly resemble leaves, on a stalk 401, within which the thumbnails of the contents of the URLs are partially or fully overlaid. A method for viewing more than a limited number of URL-indexed pages in thumbnail form allows for scrolling to display additional thumbnails, organized chronologically. Clicking on any icon (a leaf, as shown) will take the viewer to the data element associated with the depicted web-page, typically by launching a web-browser or by opening the page within an already-running browser. Also as shown, an icon associated with a particular web-page 413 may be selected and deleted from the view.

The set of URLs and their linked contents can also be displayed in a visually-ordered way using, for example, the following approaches, as exemplified in FIG. 5:
Each leaf 511 in a set of leaves (five in the example shown in FIG. 5) has a URL/URI and a thumbnail webpage associated with it. The set represents the most visited URLs in a specified time period by an individual recording their Internet browsing history to the particular file. Button 501, for example, enables a user to determine the time period. Clicking on button 501 reveals a menu 521 of time periods permitting a user to select the desired one.
The relative and/or absolute area of the leaves can be determined by the relative popularity (or frequency) of the URLs and associated thumbnails in the database within a specified time period, thereby providing a quick at-a-glance view for the user of the most popular web-sites.
Additionally, another attribute of the way the leaves are displayed (for example the color), is determined by how long, on average, users stay on a particular page. Other attributes of the leaves can represent aspects such as whether users have linked text specific to that page, and the degree to which users like or dislike a page.
Clicking on a leaf will load, in a web browser, the URL/URI associated with the thumbnail on the leaf, as shown in FIG. 5 for the leaf associated with the URL someserver.com/uri.
There can also be an icon on the leaf to show a set of additional leaves, representing the most frequent destinations navigated to from the URL/URI represented by that leaf, of users recording to this file.

### Delayed Recording

The instant technology is further directed to providing, while recording a user's data stream, a method to delay recording of one or more data elements. In the example where data elements are URL's/URI's representing web pages, users can prevent unwanted recordings while browsing through a series of URL's/URI's. The technology further provides an interface to notify the user of the delay as well as options for overriding the introduced delay.

The instant technology includes a method for, while recording a user's data stream, introducing a delay to the recording of data streams when a user navigates to a web page. The purpose of a delay is to provide an additional level of security and peace of mind to the user. The measure of security and peace of mind is due to the user's knowledge that should a data element that they do not want recorded to any database be transmitted, i.e., whether to be shared with others or kept in private possession, that they have time to prevent the recording.

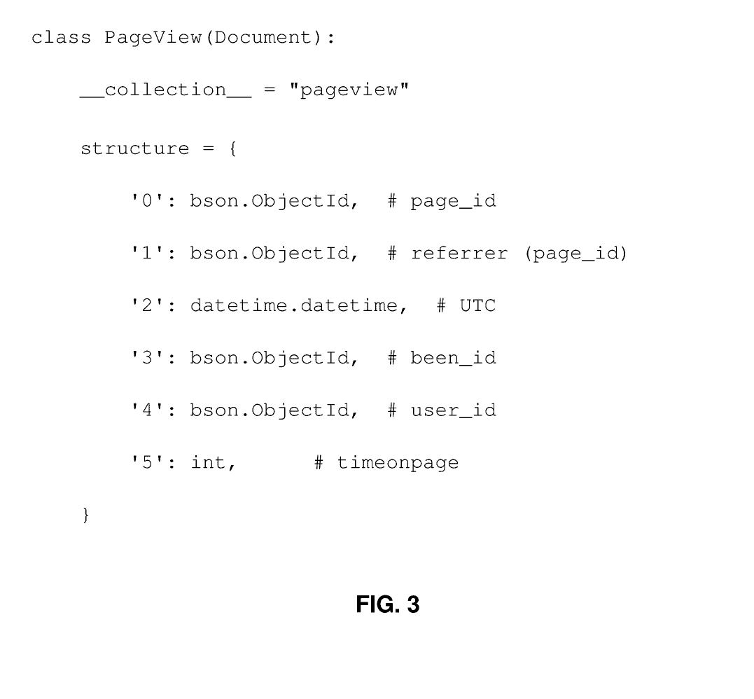

In the example where data elements are URL/URIs representing web pages, via a graphical interface, the user is informed of both the initiation of the delay and its conclusion, at which point the URL that the user has navigated to is automatically recorded to the database. FIG. 2 demonstrates such an exemplary interface in which each icon has a control feature. Thus, in FIG. 2, icons 201, 204, 206 each have a button (respectively 201, 203, and 205) which is selectable independently of the icon itself to which it is attached. The buttons control recording by being clicked to initiate and terminate recording. Typically the button indicates the state of recording so that the user can tell immediately whether recording is taking place. For example, this could be by changing color according to state. Button 201 is grey, meaning that recording is not taking place. Button 203 is yellow meaning that the current page displayed in the browser is about to be recorded. The user has a time period (say 10 s) to prevent the current webpage from being recorded. If the user navigates to a second web-page while the button is yellow, the first page will be recorded. Button 205 is red meaning that the current page has been recorded already. Other color schemes or manners of indicating the state of recording (e.g., by flags) are consistent with the technology herein. During the set delay interval, the user will be informed that the page that they are on has not yet been recorded to the data stream record.

During this time interval, the user can override the delay by either (a) navigating to another page (for those users who would like to record a series of URLs in quick succession without being encumbered by the delay technology) and (b) instructing that the current URL should be recorded without delay. The delay mechanism is the default method but can be overridden to provide a balance between privacy and convenience.

The delay functionality described herein should not cause undue inconvenience to the user who wishes to record a series of webpages (i.e., their URLs/URIs) in quick succession. The balance between convenience (recording many pages) and safety (a delay that allows users to prevent recording during a set period of time, e.g., 10 seconds) is struck by the ability of users to record the URL/URI if they navigate to another page within the duration of the delay. In other words, when a user lands on a new page, a delay is initiated which gives the user the ability to choose not to record that page. However, should the user navigate to another page during the initiated delay, that page will be recorded. And the delay will start again in this next page. Another way to override the delay, for example, would be to stay on the original page but signal to the web browsing extension to record the page without delay.

### Calculating and Viewing Histories Based on Group Viewing

At any time, a user who is a member of a group, or a third party with permission from a member of the group, may view the recording in multiple formats: either chronologically or most-visited within a certain user-chosen time interval by the entire membership in the group, e.g., last hour, last 24-hour period, last month, last year, or within a specified time period (e.g., between 2 am GMT Jan. 2, 2013 and 7 pm GMT Feb. 15, 2014).

The chronological and most-visited within a time period results can be viewed in tabular/textual format and in graphical form. In graphical form, the chronological view can be a linear view of icons representing the data elements. In the example where data elements are URL's/URI's representing web pages, the thumbnails or images of the actual URL's/URI's are shown. FIG. 4 shows how the chronological graphical view of combined data streams of a group could appear, for example when run from a browser extension on a desktop or laptop, or when run as an app on a mobile device.

The graphical form of the most-visited within a time period list can deploy different sizes of the thumbnails or images to reflect the ranking of the data elements, from the most visited data element to the least visited, respectively, for each time period.

For any given time period, the program will scan data elements that fall within the specified timeframe and that have the group ID tagged to them. The program will then determine, within that collection, the data elements that have been viewed the most (such as by count) by the members of the group.

FIG. 5 shows how the most-visited graphical view of combined data streams of a group could appear, for example when run from a browser extension on a desktop or laptop, or when run as an app on a mobile device. The example in the figure is showing the five most visited web pages within the past hour for the group.

The data items that can be recorded from member users who opt-in to join and become active members in the group correspond closely to those used for an individual user.

From the most visited list view, viewers (either users or third parties who have permission to view the data) can choose to see, either in tabular/textual view or graphical view, what data elements, as a group, the members visit from any of the data elements on the list. In other words, for each data element, there can be, depending on the available data, a set of data elements that users navigated to from the source data element. This set of data elements can be ranked and displayed in terms of the number of times they were accessed by the group members. These “subsequent” data elements are thus listed in terms of rankings from most often/popular to least often/popular. Aggregating the referrer data element data is what makes this functionality possible.

The lists of data elements created thereby can also be searched for key words in the titles, the text of the data elements, as well as of the text of the contents of the HTML.

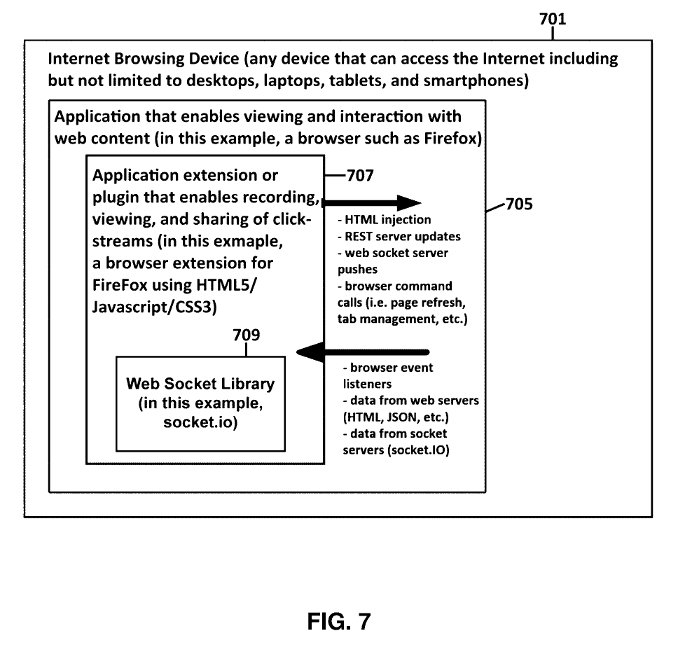

FIG. 6 shows an example of a tabular/textual view of the combined data streams of a group. For each of the URLs, the title of the webpage, the address, a summary icon denoting its popularity, a time-on-page, and the date last accessed are shown. Each of the columns can be sorted, and the data can be exported to a portable file format. Although not shown, data elements can be deleted by marking them (e.g., by checking a box in the last column) and then selecting “delete” from the “Choose Action” drop down. It is to be understood that the tabular view in FIG. 6 is exemplary: other tabular views are consistent with the technology described herein, including views having the same columns in different positions, and columns showing other types of pertinent data.

### Exemplary Implementations

The technology can be implemented to run within a web-browser, for example on a desktop personal computer or a laptop or notebook or tablet computer. The technology can also be implemented to run as an “app” (or application program) that runs on a mobile device such as a mobile or cellular phone, a personal digital assistant, or a tablet such as an iPad. When implemented to run within a browser, the technology is typically developed as a “browser extension” because it can be developed using existing browser capability, rather than as a plug-in. Different existing web-browsers refer to extensions differently: for example, the FireFox browser refers to such an object as an “add-on” where Safari, Internet Explorer, and Chrome refer to them as “extensions”. However, plug-in based implementations for any of the browsers are not precluded. When implemented to run as an app, the app also provides basic browser functionality.

It is further contemplated that the technology run in a client-server implementation, whereby the user logs in or otherwise connects from an Internet Browser Device to a server that provides the functionality for data stream monitoring.

The computer functions for managing a user's data streams, as described herein, can be developed by a programmer skilled in the art. The functions can be implemented in a number and variety of programming languages, including, in some cases mixed implementations. For example, the functions as well as scripting functions can be programmed in C, C++, Java, Python, HTML5, CSS3, JavaScript, Perl, .Net languages such as C#, and other equivalent languages. The capability of the technology is not limited by or dependent on the underlying programming language used for implementation or control of access to the basic functions. Alternatively, the functionality could be implemented from higher level functions such as tool-kits that rely on previously developed functions for manipulating data elements.

The technology for monitoring, recording, and displaying data streams, as described herein can be developed to run with any of the well-known computer operating systems in use today, as well as others, not listed herein. Those operating systems include, but are not limited to: Windows (including variants such as Windows XP, Windows95, Windows2000, Windows Vista, Windows 7, and Windows 8, available from Microsoft Corporation); Apple iOS (including variants such as iOS3, iOS4, and iOS5, iOS6, iOS7, and intervening updates to the same); Apple Mac operating systems such as OS9, OS 10.x (including but not limited to variants known as “Leopard”, “Snow Leopard”, “Mountain Lion”, “Lion”, “Mavericks”, and “Yosemite”); the UNIX operating system (e.g., Berkeley Standard version); and the Linux operating system (e.g., available from Red Hat Computing).

To the extent that a given implementation relies on other software components, already implemented, such as functions for accessing or manipulating data elements such as HTTP headers, those functions can be assumed to be accessible to a programmer of skill in the art.

Furthermore, it is to be understood that the executable instructions that cause a suitably-programmed computer to execute methods for managing a user's data streams, as described herein, can be stored and delivered in any suitable computer-readable format. This can include, but is not limited to, a portable readable drive, such as a large capacity “hard-drive”, or a “pen-drive”, such as connects to a computer's USB port, and an internal drive to a computer, and a CD-Rom or an optical disk. It is further to be understood that while the executable instructions can be stored on a portable computer-readable medium and delivered in such tangible form to a purchaser or user, the executable instructions can be downloaded from a remote location to the user's computer, such as via an Internet connection which itself may rely in part on a wireless technology such as WiFi. Such an aspect of the technology does not imply that the executable instructions take the form of a signal or other non-tangible embodiment. The executable instructions may also be executed as part of a “virtual machine” implementation.

The technology described herein can be implemented in many different ways, of which one exemplary way is as follows.

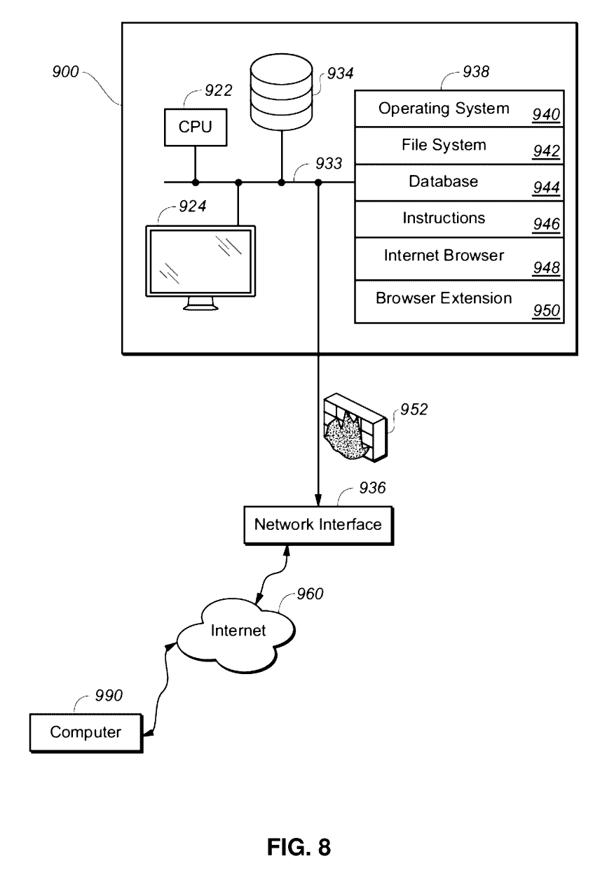

The context of a client implementation is shown in outline in FIG. 7. In this particular example, a network device such as a laptop 701, running a web-browser 705 such as FireFox with a custom browser extension 707 represents the client. The data stream monitoring software resides in the extension 707; such an extension enables the recording, viewing, and sharing of data streams.

Packaged within the custom browser extension is a web socket library 709 such as socket.IO that enables communication through WebSockets (a standard protocol) with a socket server. The browser extension can be built using HTML5, CSS3 and JavaScript to offer a user interface that enables users to control what data stream data is being recorded, and what data stream data to share while providing various ways of viewing the data. This is facilitated by event listeners and data exchanges between the browser and the browser extension through the browser add-on architecture.

Synchronous data, including logging in, is communicated between the web server and browser extension using REST and JSON while asynchronous data such as data stream data retrieval and updates is communicated between the socket server and the browser extension's client socket library using WebSockets.

API communication between the server and client is implemented over the REST or WebSockets layers, depending on the need for synchronous or asynchronous data exchange. This implementation is within the capability and knowledge of one of skill in the art.

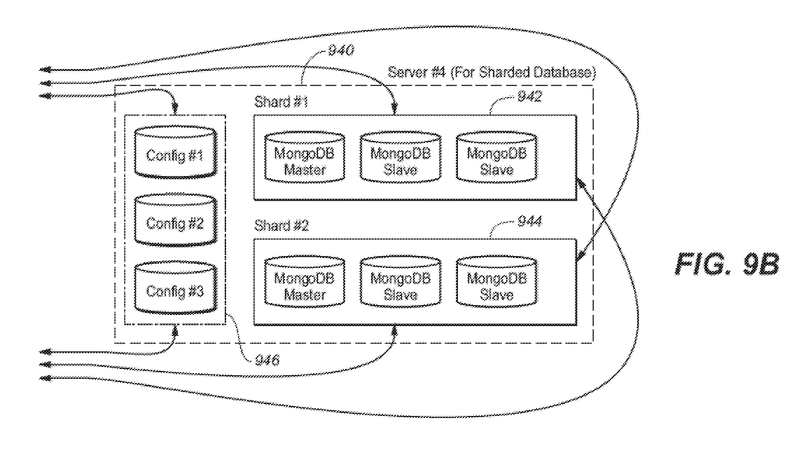

An exemplary server implementation is shown with respect to FIGS. 9A and 9B. It should be noted that simple implementations that rely on single threaded and multiple threaded instances of server use can be implemented with the capability of those of skill in the art. Such implementations address simple situations where a user connects to the server and wishes to, for example, share information about a newly-visited webpage to other members of a group. Web servers such as Tornado can handle multiple such requests from multiple users. Preferably the server utilizes a load-balancing layer.

A preferred embodiment of a database server for use with the data stream technology herein is shown schematically in FIGS. 9A and 9B. Various functions are distributed over several different servers (or server clusters) 910, 920, 930, and 940. Client side communication begins with browser 901 having a plugin 903 (resident on a computer or a mobile device). Communications are channeled through a server-side load balancer 905 before being distributed out amongst the various servers.

In this particular example, a NoSQL database such as MongoDB 913, 923, 942, 194 is employed so as to provide a flexible database structure. A flexible structure is important because it enables the storage of individual data streams while providing the ability to group them in various ways without having to restructure tables as a traditional SQL database would require. The logic for data queries and updates can be performed using the python programming language via the PyMongo interface. API's that clients can call are sourced from the PyMongo interface and exposed using either the REST of Socket.IO interfaces through the web server.

The technology also provides for Application Servers 920 (includes the Portal, REST, static, session, and social server instances). An application server that provides the logic to render web pages on the Portal which enables users to view and manage their accounts and data in greater detail than through the browser extension can be constructed using Python and Django, with the Tornado web server serving up the pages to maximize flexibility and performance. The application server uses the same API calls as the browser extension in order to re-use as much of the database querying and update logic built using PyMongo as possible.

The technology also provides for a thumbnail Server 930. In this embodiment, a separate server acts as the thumbnail server which loads data elements in recorded data streams and takes snapshots of the web pages so that they can be displayed by the clients. Various users 932 (denoted as workers ##1-4) communicate web-page thumbnails to queue 936, and thereafter to a thumbnail generator server 938. Server 938 accesses the web-page by data element and takes a snapshot of it to create a thumbnail, provided for example that a recent version of it is not already available in its cache. The web page snapshots taken do not contain any private data as they are loaded by a 3rd party server which has no personal information from any user. Thumbnail generation is managed by a queue to maximize efficiency. Static server 934 serves up unchanging or relatively slowly changing material.

The technology also provides for a Socket Server 910, as shown in FIGS. 9A and 9B. The Socket Server can be implemented using the Socket.IO library and is exposed through the Tornado web server, with the Tornado extension implemented to enable real-time persistent connections for WebSockets. Due to the single-threaded method in which the Tornado server functions, implementing the Socket.IO library requires the implementation of a multi-threading and multi-processing architecture in order to prevent blocking.

A 0 database for maximum efficiency can be handled by server 940. Three config servers (##1-3) will hold the meta data for the two sharded clusters. They will be deployed on three separate server instances to assure immediate data consistency and reliability.

The multi-threaded architecture involves a single web server process servicing many worker threads that process requests in parallel.

The multi-processing architecture also involves scaling the multi-threaded system to many processors (either machines or virtual systems) using load balancers.

### Computing Apparatus

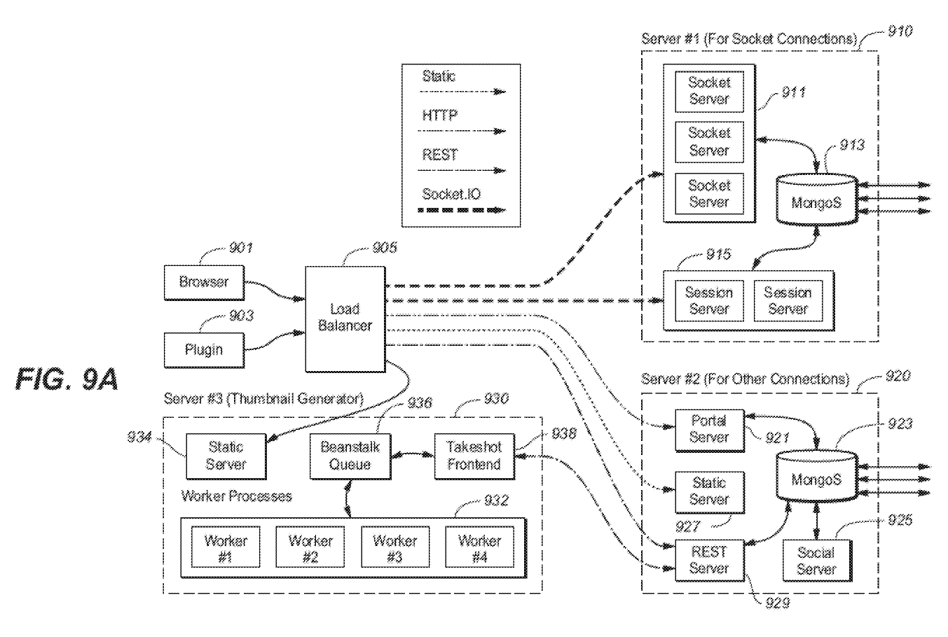

An exemplary general-purpose computing apparatus 900 suitable for practicing client-side methods described herein is depicted schematically in FIG. 8. Such a system could be used by any user who wishes to monitor and record their data streams, as described herein.

The computer system 900 comprises at least one data processing unit (CPU) 922, a memory 938, which will typically include both high speed random access memory as well as non-volatile memory (such as one or more magnetic disk drives), a user interface 924, one more disks 934, and at least one network connection 936 or other communication interface for communicating with other computers over a network, including the Internet 960, as well as other devices, such as via a high speed networking cable, or a wireless connection. There may optionally be a firewall 952 between the computer 900 and the Internet 960. At least the CPU 922, memory 938, user interface 924, disk 934 and network interface 936, communicate with one another via at least one communication bus 933.

Memory 938 stores procedures and data, typically including some or all of: an operating system 940 for providing basic system services; one or more application programs, such as a web-browser 948 and a browser extension 950, and a compiler (not shown in FIG. 8), a file system 942, one or more databases 944 that store data such as data streams or user or group data, and optionally a floating point coprocessor where necessary for carrying out mathematical operations. The methods of the present technology may also draw upon functions contained in one or more dynamically linked libraries, not shown in FIG. 8, but stored either in memory 938, or on disk 934.

The database and other routines shown in FIG. 8 as stored in memory 938 may instead, optionally, be stored on disk 934 where the amount of data in the database is too great to be efficiently stored in memory 938. The database may also instead, or in part, be stored on one or more remote computers that communicate with computer system 900 through network interface 936, according to methods as described herein.

Memory 938 is encoded with instructions 946 for at least: carrying out recording operations; manipulating data elements; and for accessing database records. In some embodiments, the database is not stored on the computer 900 that performs the display or monitoring but is stored on a different computer (not shown) and, e.g., transferred via network interface 936 to computer 900.

Various implementations of the technology herein can be contemplated, particularly as performed on one or more computing apparatuses of varying complexity, including, without limitation, workstations, PC's, laptops, notebooks, tablets, netbooks, and other mobile computing devices, including cell-phones, mobile phones, and personal digital assistants. The computing devices can have suitably configured processors, including, without limitation, graphics processors and math coprocessors, for running software that carries out the methods herein. In addition, certain computing functions are typically distributed across more than one computer so that, for example, one computer accepts input and instructions, and a second or additional computers receive the instructions via a network connection and carry out the processing at a remote location, and optionally communicate results or output back to the first computer.

Control of the computing apparatuses can be via a user interface 924, which may comprise a display, mouse, keyboard, and/or other items not shown in FIG. 8, such as a track-pad, track-ball, touch-screen, stylus, speech-recognition device, gesture-recognition technology, human fingerprint reader, or other input such as based on a user's eye-movement, or any subcombination or combination of inputs thereof.

The manner of operation of the technology, when reduced to an embodiment as one or more software modules, functions, or subroutines, can be in a batch-mode—as on a stored database of URL's/URI's, processed in batches.

The data streams can be displayed in tangible form, such as on one or more computer displays, such as a monitor, laptop display, or the screen of a tablet, notebook, netbook, or cellular phone. The data streams, can further be printed to paper form, stored as electronic files in a format for saving on a computer-readable medium or for transferring or sharing between computers, or projected onto a screen of an auditorium such as during a presentation.

Certain default settings can be built in to a computer-implementation, but the user can be given as much choice as he or she desires over the features that are used in recording and monitoring data streams.

All references cited herein are incorporated by reference in their entireties.

The foregoing description is intended to illustrate various aspects of the instant technology. It is not intended that the examples presented herein limit the scope of the appended claims. The invention now being fully described, it will be apparent to one of ordinary skill in the art that many changes and modifications can be made thereto without departing from the spirit or scope of the appended claims.

What is claimed:

1. A computing apparatus for managing a user's data streams, the apparatus comprising:
a computer-readable memory, encoded with instructions;
a processor executing the instructions;
wherein the instructions provide for:
recording a user's data stream, wherein the data stream comprises two or more data elements;
associating one or more pieces of user-specific information with each of the two or more data elements; and
sharing the data stream with one or more third parties.

2. The computing apparatus of claim 1, wherein the one or more pieces of user-specific information are selected from the group consisting of: name, age, gender, location, e-mail address, and telephone number.

3. A method for managing a user's data streams, the method comprising:
recording a user's data stream, wherein the data stream comprises two or more data elements;
associating one or more pieces of user-specific information with each of the two or more data elements; and
sharing the data stream with one or more third parties,
wherein the method is performed on a computing apparatus.

4. A computer-readable medium encoded with instructions for implementing the method of claim 3.

5. A computing apparatus for displaying a user's data stream, the apparatus comprising:
a computer-readable memory, encoded with instructions;
a processor configured to execute the instructions;
wherein the instructions provide for:
recording the data stream of a user, wherein the data stream comprises one or more data elements;
storing the data stream in a database;
generating an icon for each of the one or more data elements based on the length of time spent by the user on the data element; and
displaying, on a computer display, the icon for each of the one or more data elements.

6. The apparatus of claim 5, wherein the instructions further comprise:
associating one or more pieces of user-specific information with each of the one or more data elements in a user's data stream; and
storing the one or more pieces of information in the database in conjunction with the stored data elements.

7. A method for displaying a user's data stream, the method comprising:
recording the data stream of a user, wherein the data stream comprises one or more data elements;
storing the data stream in a database;
generating an icon for each of the one or more data elements based on the length of time spent by the user at the data element; and
displaying, on a computer display, the icon for each of the one or more data elements;
wherein the method is performed on a computing apparatus.

8. The method of claim 7, further comprising:
associating one or more pieces of user-specific information with each of the one or more data elements in a user's data stream; and
storing the one or more pieces of information in the database in conjunction with the stored data element.

9. The method of claim 7, wherein the data stream comprises elements from the user's Internet session.

10. A computer-readable medium encoded with instructions for implementing the method of claim 7.

11. The computing apparatus of claim 1, wherein the data stream is transmitted on a medium selected from the group consisting of: Internet protocol; audio; video; text messages; geolocation; near field communication; Bluetooth; and infrared.

12. The computing apparatus of claim 11, wherein the Internet protocol medium is selected from TCP/IP, HTTP, SMTP, and VoIP.

13. The computing apparatus of claim 12, wherein the Internet protocol medium is HTTP and the one or more data elements are selected from: URL/URI; user-agent; and message body.

14. A data exchange wherein data streams of users, or data streams of groups of users, can be shared by the users in exchange for compensation, the method comprising:
sharing on a real-time basis where users can choose to share a set of their data to providers, advertisers, merchants, and advertising and auction exchanges, or other third parties;
sharing on a continuous basis where users agree to share their data continuously in the background through a common information exchange and processing mechanism; and
the common information exchange and processing mechanism be facilitated through an API that enables providers, advertisers, merchants, and advertising and auction exchanges, or other third parties to read and package content and advertisements based on the users' data.

15. The data exchange in claim 14, wherein users can further control:
whether or not app developers, publishers, advertisers, merchants or other third parties can collect users' data streams and groups of users' data streams; and
whether or not advertisements will be displayed.
